(19) United States
(12) Patent Application Publication
(10) Pub. No.: US 2009/0224974 A1
(43) Pub. Date: Sep. 10, 2009

(54) Power efficient global positioning system receiver

(75) Inventor: Robert G. Lorenz, Menlo Park, CA (US)

Correspondence Address: VAN PELT, YI & JAMES LLP, 10050 N. FOOTHILL BLVD #200, CUPERTINO, CA, 95014, US

(73) Assignee: NavASIC Corporation

(21) Appl. No.: 12/074,556

(22) Filed: Mar. 4, 2008

(51) Int. Cl. G01S 1/00

(52) U.S. Cl. 342/357.12

(57) ABSTRACT

A Global Positioning System (GPS) receiver is configurable to switch between a power saving mode and a non-power saving mode. The GPS receiver includes a reference oscillator configured to provide a reference clock, a frequency synthesizer coupled to the reference oscillator, configured to provide a sampling clock to an analog to digital converter; and a compensation module configured to compensate for a change in phase relationship between the sampling clock and the reference clock, the change resulting from the GPS receiver switching between the power saving mode and the non-power saving mode.

### BACKGROUND OF THE INVENTION

FIG. 1 is a block diagram illustrating a typical Global Positioning System (GPS) receiver. In this example, device 100 includes a radio frequency (RF) portion, which includes an antenna 102, a low noise amplifier (LNA) 104, and a mixer 110. The RF portion further includes an oscillator 106 and a frequency synthesizer 108. The frequency synthesizer generates a local oscillator signal based on the output of oscillator 106. The local oscillator signal is used to down-convert the received signal, providing an intermediate frequency (IF) signal to be processed by IF processor 112. The local oscillator signal is divided in frequency by divider 114 to generate a sampling clock for analog to digital converter (ADC) 116. The output of the ADC is sent to a baseband digital signal processor (DSP) 118, which processes the signal according to GPS computation techniques to generate GPS measurement results such as position and time. A typical GPS receiver continuously receives signal samples and computes GPS outputs, where the computation gives some weight to the previously computed outputs.

In some GPS receivers, portions of the receiver circuit are disabled intermittently to save power. During these periods, the GPS signal is not received. Aside from the oscillator, which remains active at all times, components of the RF section may be selectively disabled; one such component is the frequency synthesizer. In some GPS receivers, the ADC sampling clock is derived from the frequency synthesizer. One drawback of this power saving method in such GPS receivers is that once the frequency synthesizer is re-enabled, it may initialize in a random phase, thus causing the sample time of the ADC to shift in an unpredictable manner. Existing GPS receivers typically do not account for the timing shifts when incorporating previously made measurements. Other GPS receivers discount previously made measurements to accommodate this timing shift.

It would be useful to have a GPS receiver that is power efficient. It would also be desirable to have a power efficient GPS receiver that provides more accurate results than the existing devices.

### BRIEF DESCRIPTION OF THE DRAWINGS

Various embodiments of the invention are disclosed in the following detailed description and the accompanying drawings.

FIG. 1 is a block diagram illustrating a typical GPS receiver.

FIG. 2 is a block diagram illustrating an embodiment of a compensating GPS receiver.

FIG. 3A is a flowchart illustrating an embodiment of a process for processing a GPS signal in a power efficient GPS receiver.

FIG. 3B is a flowchart illustrating another embodiment of a process for processing a GPS signal in a power efficient GPS receiver.

FIG. 4 is a block diagram illustrating an embodiment of a compensation module coupled to a GPS signal processor.

FIG. 5 is a flowchart illustrating an embodiment of a process for compensating the timing offset.

FIGS. 6A-6B are timing diagrams illustrating the timing of various signals in an embodiment of a compensated GPS receiver.

FIG. 7 is a diagram illustrating the convergence of the phase bounds.

FIG. 8 is a block diagram illustrating an embodiment of a timing module.

FIG. 9 is a block diagram illustrating an embodiment of a bounds estimator module.

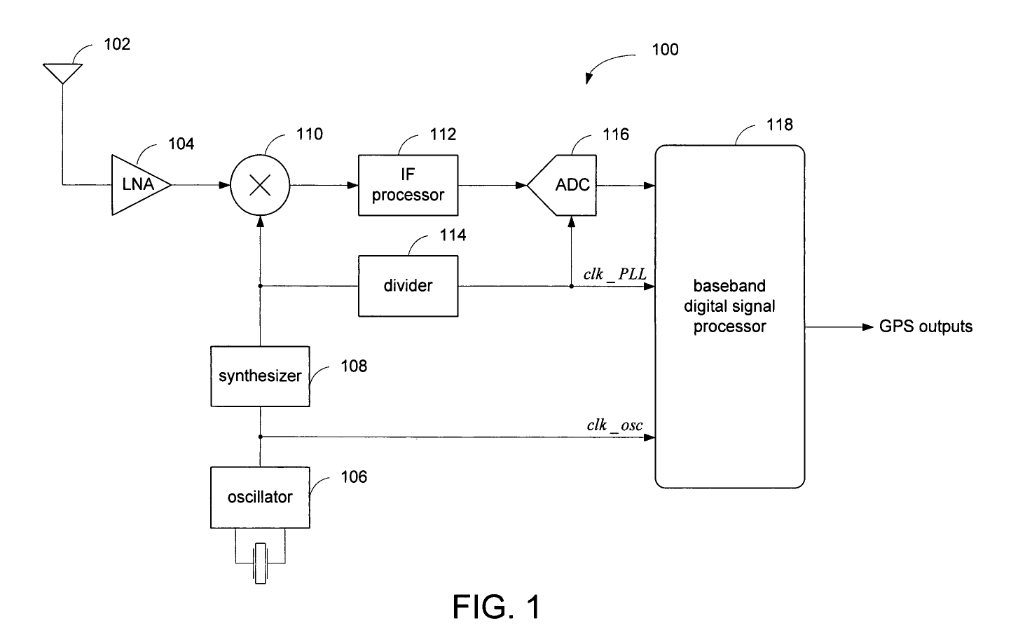

### DETAILED DESCRIPTION

The invention can be implemented in numerous ways, including as a process, an apparatus, a system, a composition of matter, a computer readable medium such as a computer readable storage medium. In this specification, these implementations, or any other form that the invention may take, may be referred to as techniques. A component such as a processor or a memory described as being configured to perform a task includes both a general component that is temporarily configured to perform the task at a given time or a specific component that is manufactured to perform the task. In general, the order of the steps of disclosed processes may be altered within the scope of the invention.

A detailed description of one or more embodiments of the invention is provided below along with accompanying figures that illustrate the principles of the invention. The invention is described in connection with such embodiments, but the invention is not limited to any embodiment. The scope of the invention is limited only by the claims and the invention encompasses numerous alternatives, modifications and equivalents. Numerous specific details are set forth in the following description in order to provide a thorough understanding of the invention. These details are provided for the purpose of example and the invention may be practiced according to the claims without some or all of these specific details. For the purpose of clarity, technical material that is known in the technical fields related to the invention has not been described in detail so that the invention is not unnecessarily obscured.

A power efficient GPS receiver and its operations are disclosed. The GPS receiver is configurable to switch between a power saving mode and a non-power saving mode. In some embodiments, the GPS receiver includes a reference oscillator configured to provide a reference clock, a frequency synthesizer configured to provide a sampling clock to an analog to digital converter, and a compensation module configured to compensate for a change in phase relationship between the sampling clock and the reference clock, resulting from the GPS receiver switching between the power saving mode and the non-power saving mode.

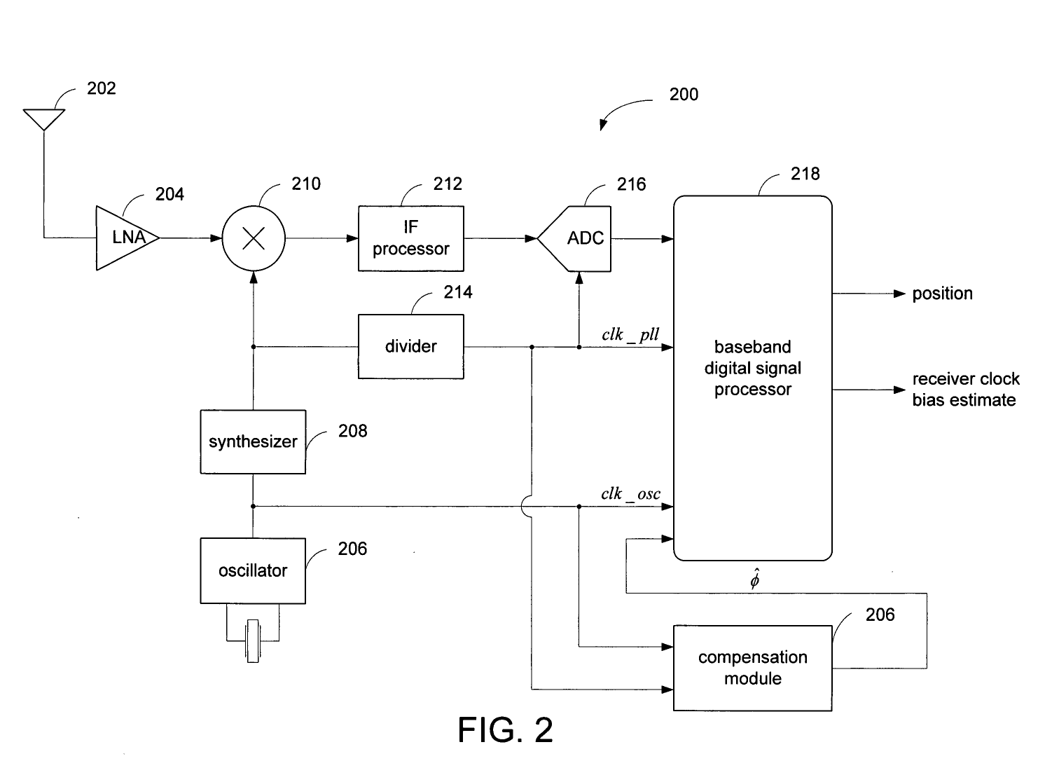

FIG. 2 is a block diagram illustrating an embodiment of a compensating GPS receiver. In the example shown, the RF portion of receiver 200 includes an antenna 202, an LNA 204, an oscillator 206, a frequency synthesizer 208, and a mixer 210. In some embodiments, the oscillator is a temperature compensated crystal oscillator. The output of the oscillator is referred to as the reference clock, and is denoted as clk_osc. The reference oscillator is coupled to a frequency synthesizer 208, either directly or indirectly, and sends the reference clock signal to frequency synthesizer 208. In some embodiments, the frequency synthesizer is implemented as a fractional-N synthesizer that employs a phase locked loop (PLL) to control the output frequency of the frequency synthesizer. In this example, the frequency synthesizer output is used to down-convert the received signal, providing an IF signal to be processed by an optional IF processor 212.

Divider 214 divides the frequency synthesizer output signal to generate an ADC sampling clock (denoted as clk_PLL since this clock frequency is generated by a PLL in the frequency synthesizer) used by ADC 216 for sampling the output of the IF processor. In some embodiments, ADC 216 may include a separate sampler and analog to digital converter. Using a frequency divider coupled with a frequency synthesizer allows a fixed sampling frequency to be generated independent of the choice of the reference clock frequency. The output of the ADC, the ADC sampling clock (clk_PLL), and the reference clock (clk_osc), are sent to a processor, in this case a baseband DSP 218. Additionally, the baseband DSP receives as its input an estimated phase offset \hat{φ}₀, which is generated by a compensation module 206.

The inputs to the compensation module include the sampling clock clk_PLL and the reference clock clk_osc. The output of the compensation module includes \hat{φ}₀, which is an estimate of the phase relationship (i.e., the relative phase offset) between clk_PLL and clk_osc. The compensation module is configured to compensate for a change in the phase relationship between the sampling clock and the reference clock (or, equivalently, a change in timing offset between the clock signals) resulting from the GPS receiver switching between the power saving mode and non-power saving mode. In various embodiments, the compensation module may be implemented using special purpose hardware, general purpose processor, or a combination. For example, in some embodiments, the compensation module includes special purpose hardware for estimating the phase relationship and one or more general purpose processors to perform compensation calculations based on the phase relationship. Other implementations are possible. The operations of the compensation module and the baseband DSP are described in more detail below. For purposes of illustration, the compensation module and the DSP module are shown to be separate logical components in the example, although in some embodiments they are combined as a single physical module or implemented in a single integrated circuit.

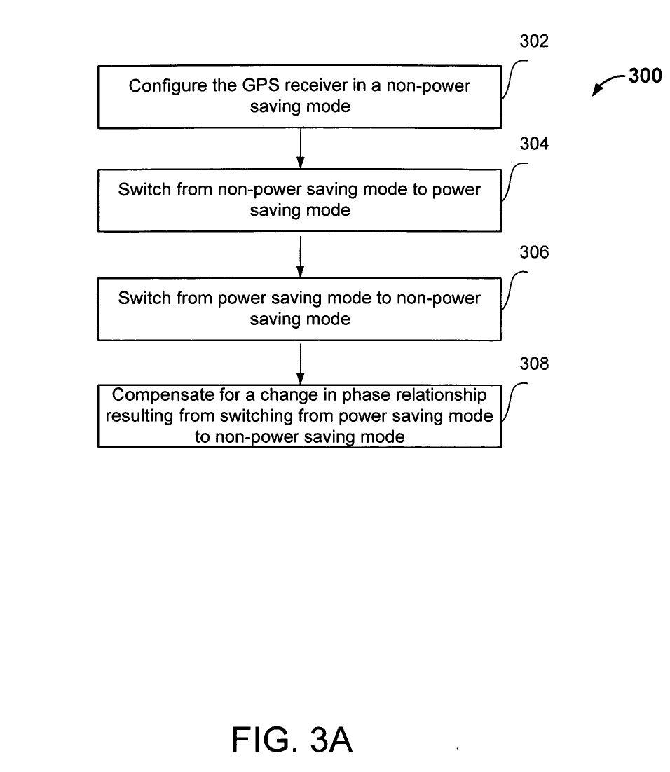

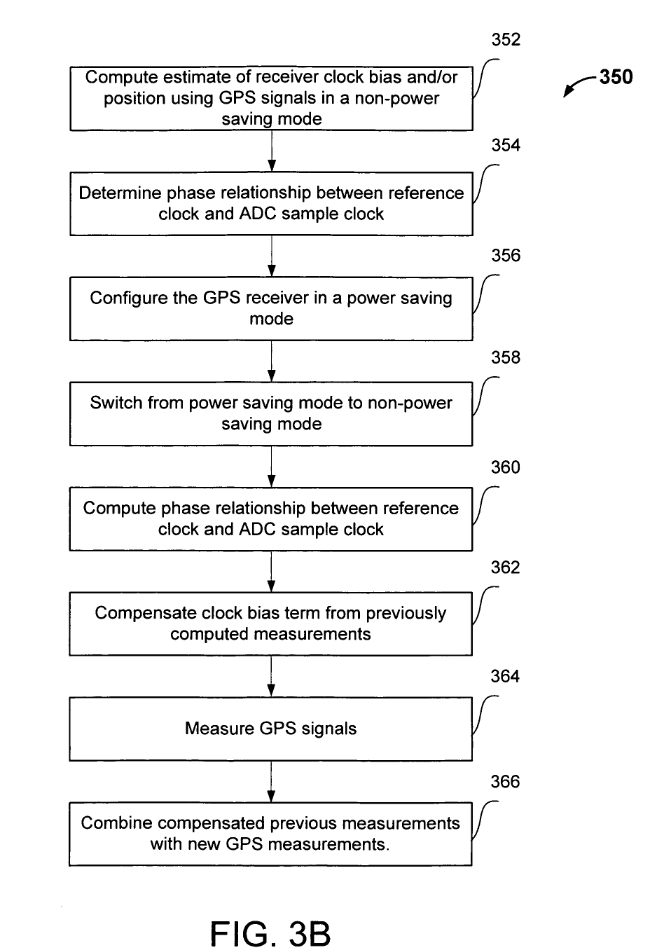

FIG. 3A is a flowchart illustrating an embodiment of a process for processing a GPS signal in a power efficient GPS receiver. Process 300 may be implemented on device 200 shown in FIG. 2. In the example shown, at 302, the GPS receiver is configured in a non-power saving mode. At 304, the GPS receiver switches from the non-power saving mode to a power saving mode. During the power saving mode, at least a portion of the GPS receiver is disabled, disconnected from the power supply, placed in a standby/sleep setting, or otherwise configured such that this portion of the circuitry consumes less power than it would in a non-power saving mode. In some embodiments, the RF module of the GPS receiver is switched to power saving mode, and additional GPS receiver components may optionally be switched to the power saving mode as well. In some embodiments, such as 200 of FIG. 2, where the RF module includes a reference oscillator and a frequency synthesizer, the frequency synthesizer is switched off during the power saving mode while the reference oscillator continues to oscillate.

At 306, the GPS receiver is switched again, this time from the power saving mode to the non-power saving mode. In other words, the GPS receiver now operates in a mode that consumes more power than during the power saving mode. The RF module, as well as any additional GPS receiver modules that were optionally placed in the power saving mode, are switched from the power saving mode to the non-power saving mode. The frequency synthesizer may power on with a random phase when it switches to the non-power saving mode. Since the ADC sampling clock is derived from the frequency synthesizer output, this random starting phase of the frequency synthesizer introduces a random offset in the time at which the downconverted GPS signal is sampled. This manifests as a change in the receiver clock bias relative to the clock bias computed during 302. At 308, the change in the phase relationship between the reference clock and the sampling clock is compensated. Further details of the compensation are described below.

FIG. 3B is a flowchart illustrating another embodiment of a process for processing a GPS signal in a power efficient GPS receiver. The compensation process is shown in greater detail in this example. At 352, the GPS receiver is configured in a non-power saving mode. During this period, the GPS receiver processes the received GPS signal and computes an estimate of the receiver clock bias, position, or both. At 354, the phase of the ADC sampling clock, clk_PLL is measured relative to a predetermined rising edge of the reference clock, clk_osc. At 356, the GPS receiver switches to a power saving mode. At 358, the GPS receiver is switched from the power saving mode to the non-power saving mode. At 360, the phase relationship of the ADC sampling clock, clk_PLL, is again measured relative to a predetermined rising edge of the reference clock, clk_osc. At 362, the phase relationship measured in 350 is compared with the phase relationship measurement taken in 354. Based upon the difference in these phase relationships, the number of cycles of clk_osc between these measurements, and the frequencies of clk_osc and clk_PLL, the random timing offset introduced by steps 356 and 358 is determined. At 362, the random timing offset computed at 360 is used to compensate the clock bias term computed during 352. Alternately, a correction term may be computed and applied to subsequent measurements. At 364, the GPS receiver measures GPS signals from one or more satellites. These measurements may include pseudorange, carrier phase, and carrier frequency. At 366, the measurements taken at 364 are combined with the compensated earlier estimates of user position or clock bias.

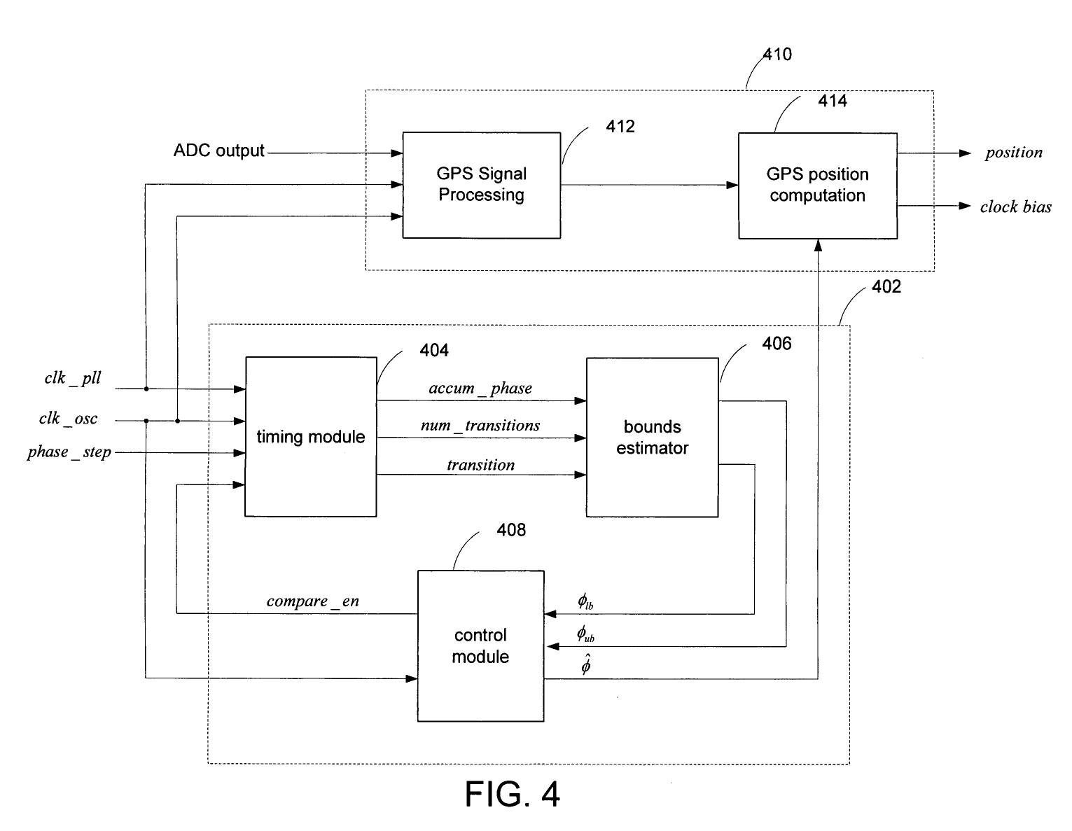

FIG. 4 is a block diagram illustrating an embodiment of a compensation module coupled to a GPS DSP. In this example, compensation module 402 includes a timing module 404, a bounds estimator 406, and a control module 408. DSP module 410 includes a GPS signal processing module 412 and a GPS position computation module 414. The output of the ADC, the ADC sampling clock, clk_PLL, and the reference clock, clk_osc, are sent to the GPS signal processing module 412, which performs standard GPS based signal processing. The signals clk_PLL and clk_osc are also sent to timing module 404. Two additional signals phase_step and compare_en are also sent to the timing module. The signal phase_step is a numerical approximation to the ratio of the sampling clock frequency (f_{PLL}) to the reference clock frequency (f_{osc}). The value of phase_step is a known value since the clock frequencies are known for a given setting of the fractional-N synthesizer. The signal compare_en triggers the relative phase measurement between clk_PLL and clk_osc in advance of the receiver switching to a power saving mode and after the receiver switches from the power saving mode to the non-power saving mode. The timing module computes intermediate values including accum_phase, num_transitions, and transition, which are used by bounds estimator 406 to determine the upper and lower bounds of the phase offset. Control module 408 is responsive to clk_osc. It computes the estimated phase offset \hat{φ}₀ based on the upper and lower bounds, and generates the compare_en signal that starts the estimation process in response to a desired rising edge of clk_osc.

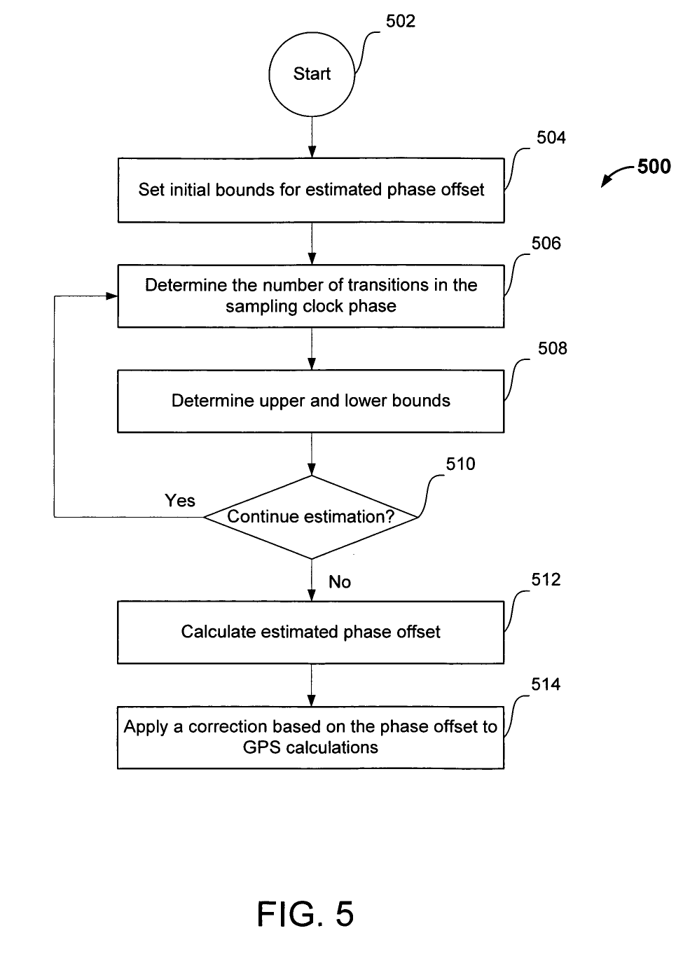

FIG. 5 is a flowchart illustrating an embodiment of a process for compensating the timing offset. Process 500 may be implemented using a compensation module such as 206 or 402. In this example, the process determines an upper bound and a lower bound of the phase offset in the sampling clock (502-510) and applies the estimate to GPS computations (512-514).

At 502, the estimation process starts in advance of a switch from the non-power saving mode to the power saving mode or after a switch from the power saving mode to the non-power saving mode. At 504, initial upper and lower bounds for the phase offset are set. If prior information about the phase offset is available, it may be reflected in the initial upper and lower bounds; absent prior information about the phase offset, an initial upper bound of 1 cycle and an initial lower bound of 0 may used. For counters and flip-flops that are synchronous logic elements responsive to transitions from a logical value of 0 to a logical value of 1 on their respective clock inputs, the transitions are referred to as rising edges. At 506, in response to the rising edge of the reference clock (clk_osc), the number of rising edges of the ADC sampling clock (clk_PLL) during the previous reference clock cycle is determined. In some embodiments, a binary counter is used to count the number of rising edges in clk_PLL. Since the least significant bit (LSB) of a binary counter toggles in value every time a rising edge occurs on its clock input, in some embodiments the LSB of the counter is used to determine whether a transition has occurred. At 508, the lower or the upper bound of the sampling clock phase is computed and updated. In some embodiments, if a rising edge of the ADC sampling clock occurred in the most recent clock cycle, the lower bound on the phase is calculated. If no transition occurred, the upper bound is calculated. The calculation depends on the previous lower or upper bound values, the number of transitions and the cumulative phase of the sampling clock since the computation began.

At 510, it is determined whether the estimation process should continue. In some embodiments, the estimation process continues at 506 until the upper and lower bounds converge to their respective limits and further estimation does not improve the values. In some embodiments, the estimation process continues until the difference between the upper and lower bounds reduces to an acceptable threshold. In some embodiments, the estimation process continues until the number of iterations equals a predetermined limit. In the event that the estimation process should continue, 506-510 are repeated. Else, at 512, an estimated phase offset value is computed based on the upper and lower bounds. In some embodiments, the phase offset value is an average of the upper and lower bounds. At 514, a correction based on the phase offset is applied to a set of GPS measurements, resulting in a set of compensated GPS calculations.

In the above example, the phase of the ADC sampling clock (clk_PLL) is compared to the phase of a predetermined rising edge of the reference clock (clk_osc). In some embodiments, the phase of the reference clock is compared to the phase of a predetermined rising edge of sampling clock. In these embodiments, in response to the rising edge of the ADC sampling clock, the number of rising edges of the reference clock during the previous ADC sampling clock cycle is determined. In this case, a binary counter may used to count the number of rising edges in clk_osc.

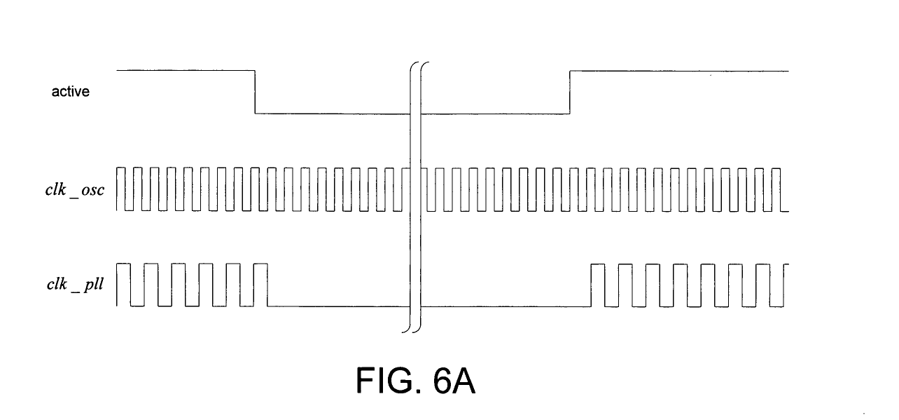

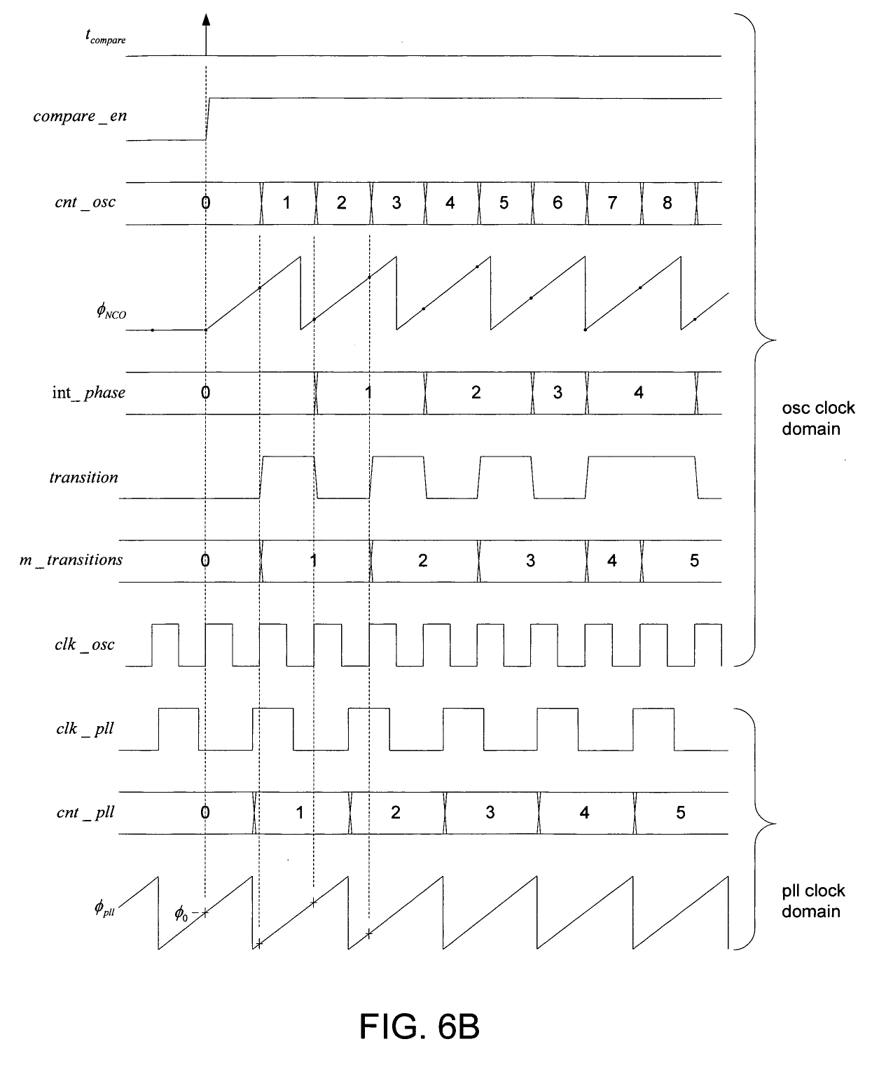

FIGS. 6A-6B are timing diagrams illustrating the timing of various signals in an embodiment of a compensated receiver. In FIG. 6A, the active signal is high when the receiver is in the non-power saving mode, and is low when the receiver is in the power saving mode. The reference clock clk_osc is active the entire time during both modes. The ADC sampling clock clk_PLL corresponds to a divided-down version of the fractional-N synthesizer output which is used to down-convert the received GPS signal. The signal clk_PLL is only active during the time the receiver is in the non-power saving mode. When the frequency synthesizer reinitializes as the receiver switches from the power saving mode to the non-power saving mode, it may initialize with a random phase and therefore cause the sample time of the ADC to shift in an unpredictable manner. The shift in the sample time introduces a random shift in the clock bias term of the GPS position solution for the measurement relative to measurements taken prior to entering the power save mode.

In FIG. 6B, the phase difference between clk_osc and clk_PLL at a point in time labeled as t_{compare} is determined. In this example, t_{compare} corresponds to the point in time after the receiver switches from a power saving mode to a non-power saving mode and the frequency synthesizer restarts with a random phase offset relative to the reference clock. To help make the phase offset determination, the reference clock and the PLL clock are coupled to counters responsive to the rising edges of the clk_osc and clk_PLL signals, respectively. The states of the reference and PLL counters correspond to cnt_osc and cnt_PLL in the diagram, respectively. As shown in the signal diagrams, counter cnt_osc increments by 1 in response to each rising edge of clk_osc, and counter cnt_PLL increments by 1 in response to each rising edge of clk_PLL. At t_{compare}, the computation cycle begins and a synchronous enable signal compare_en is applied to the counters to start counting.

The underlying fractional phase of the clk_PLL signal is represented by the PLL signal, which has a saw tooth waveform since the phase has a value of zero on the rising edges of clk_PLL and increases linearly between 0 and 1 cycle as a function of time.

In some embodiments, a numerically controlled oscillator (NCO) is programmed to overflow at a frequency approximately equal to that of clk_PLL is implemented. To do this, the frequency input to the NCO, phase_step, is set to, or approximately equal to, ratio of the frequency of clk_PLL divided by the frequency of the reference oscillator clk_osc, i.e.,

$$phase\_step = \frac{{f}_{PLL}}{{f}_{osc}} . \qquad [ 1 ]$$

The phase of the numerically controlled oscillator, φ_{NCO}, is initialized to zero. Thus, φ_{NCO} and φ_{PLL} oscillate at approximately the same frequency (subject to the numerical precision of the NCO) and have a phase difference of φ₀. The phase of the NCO is given by the following recursion:

φ_{NCO}(k+1)=rem(φ_{NCO}(k)+phase_step,1), [2]

where k denotes the iteration number, rem( ) is a function that computes the remainder of the first argument modulo the second argument, and φ_{NCO}(0)=0.

Since the phase of the NCO overflows at the same frequency as the φ_{PLL} signal, the timing offset between a particular rising edge of osc_clk and the clk_pll signals can be determined based on the difference in phase between the φ_{NCO} and the underlying phase of the sampling clock, φ_{PLL}.

While φ_{PLL} is not directly visible, upper and lower bounds on its value can be inferred by observing, over a plurality of cycles of clk_osc, whether a clk_PLL phase transition occurred during the most recent clk_osc period. In some embodiments, the clk_PLL transition is detected based on changes in the LSB of cnt_PLL between successive rising clock transitions of clk_osc. The lower and upper bounds of the initial phase, φ₀, are denoted as φ_{lb} and φ_{ub}, respectively. If there was a change in cnt_PLL in the cycle immediately before, the lower bound φ_{lb} is computed as follows:

φ_{lb}(k)=max(φ_{lb}(k−1),num_transitions−accum_phase), [3]

where k is the cnt_osc value, num_transitions corresponds to the number of detected changes in the state of cnt_PLL, and accum_phase corresponds to the total amount of phase change in clk_PLL that has occurred since t_{compare}. Mathematically, accum_phase is expressed as follows:

accum_phase=cnt_osc·phase_step. [4]

The quantity accum_phase can be expressed as a sum of its integer portion and its fractional portion, which are denoted as int_phase and φ_{NCO}, respectively.

If there was no change in cnt_PLL in the cycle immediately before, the upper bound is computed as follows:

φ_{ub}(k)=min(φ_{ub}(k),num_transitions+1−accum_phase) [5]

Returning to FIG. 6B, an example of how to determine the phase offset is illustrated using the timing diagrams. In this example,

$$\frac{{f}_{PLL}}{{f}_{osc}} = \frac{4}{7} ,$$

where f_{PLL} denotes the frequency of the clk_PLL and f_{osc} denotes the frequency of the reference clock signal. Accordingly, phase_step is set to 4/7. This ratio is known and fixed at the time of phase offset estimation.

The signal t_{compare} corresponds to predetermined rising edge of clk_osc. The phase of the NCO, φ_{NCO}, and the states of the counters int_phase, cnt_osc, and cnt_PLL are reset to 0 and become responsive to rising edges of their respective clock signals only after t_{compare}. Since nothing about the value of φ_{PLL} is known at this time, the lower and upper bounds of the initial phase φ₀ are set to 0 and 1, i.e., φ_{lb}(0)=0 and φ_{ub}(0)=1.

After one cycle of clk_osc, cnt_osc=1, and

$$accum\_phase = \frac{4}{7} .$$

The values of int_phase, the integer portion of accum_phase equals zero. The fractional component of accum_phase, φ_{NCO} equals 4/7. A change in the least significant bit of cnt_PLL is detected; therefore, num_transitions=1. This change corresponds to a 0-to-1 transition in the clk_PLL signal, which implies that φ₀≧1-phase_step. Had φ₀ been less than (1-phase_step), no such transition would have occurred. Based on equation [3], the lower bound on the initial phase

$${φ}_{lb} = 1 - phase\_step = \frac{3}{7} .$$

After two cycles of clk_osc, cnt_osc=2, and

$$accum\_phase = 2 \cdot \frac{4}{7} = 1 + \frac{1}{7} .$$

No transition in the least significant bit of cnt_pll is detected; hence, num_transitions remains 1. Based on equation [5],

$$\begin{matrix}{φ}_{ub} ( 2 ) = min ( {φ}_{ub} ( 1 ) , 1 + 1 - accum\_phase ) \\ = min ( 1 , \frac{6}{7} ) \\ = \frac{6}{7} .\end{matrix}$$

On the following cycle of clk_osc, cnt_osc=3,

$$\begin{matrix}accum\_phase = 3 \cdot \frac{4}{7} \\ = 1 + \frac{5}{7} .\end{matrix}$$

A transition is detected in the least significant bit of cnt_pll, results in num_transitions=2. Based on equation [3],

$$\begin{matrix}{φ}_{lb} ( 3 ) = max ( {φ}_{lb} ( 2 ) , 2 - accum\_phase ) \\ = max ( \frac{3}{7} , \frac{2}{7} ) \\ = \frac{3}{7} .\end{matrix}$$

In this case, the new sample does not tighten the existing lower bound on the phase.

On the following cycle of clk_osc, cnt_osc=4,

$$accum\_phase = 2 + \frac{2}{7} .$$

No transition is detected since the least significant bit of cnt_PLL has not changed; therefore, num_transitions=2. Based on equation [5], the upper bound obtained based on this sample is

$$\begin{matrix}{φ}_{ub} ( 4 ) = min ( {φ}_{ub} ( 3 ) , 2 + 1 - ( 2 + \frac{2}{7} ) ) \\ = min ( \frac{6}{7} , \frac{5}{7} ) \\ = \frac{5}{7} .\end{matrix}$$

This upper bound is lower than the previous upper bound.

On the following cycle of clk_osc, cnt_osc=5,

$$accum\_phase = 2 + \frac{6}{7} .$$

A transition is detected in the least significant bit of cnt_PLL. The resulting num_transitions=3. Based on equation [3],

$${φ}_{lb} ( 5 ) = \frac{3}{7} .$$

This is equivalent to the existing lower bound.

On the following cycle of clk_osc, cnt_osc=6,

$$accum\_phase = 3 + \frac{3}{7} .$$

No transition is detected in least significant bit of cnt_PLL num_transitions remains 3. As such,

$${φ}_{ub} ( 6 ) = \frac{4}{7} .$$

The upper bound is further improved.

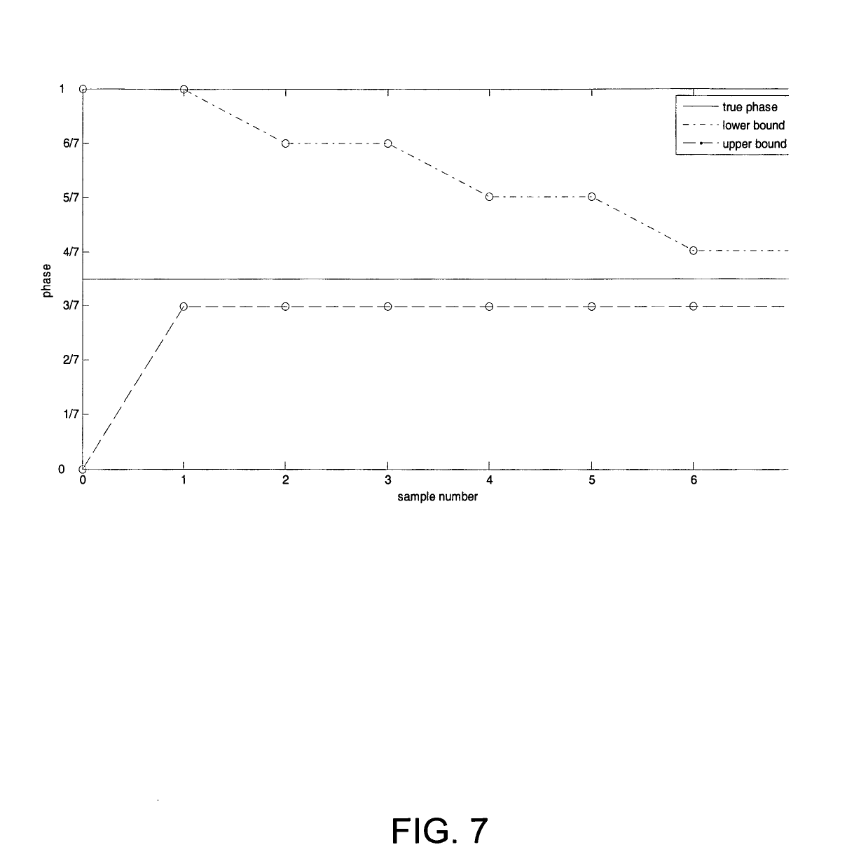

The subsequent samples will not improve the gap between the upper and lower bounds on the phase. FIG. 7 is a diagram illustrating the convergence of the phase bounds. The final phase uncertainty of the example above is 1/7. Let f_{LCM} denote the least common multiple of the frequencies f_{osc} and f_{PLL}. If the numerical precision of the implementation and the number of samples considered are both sufficient, the final phase uncertainty (i.e., the final gap between the upper and lower bounds of the phase) is given by

$$\frac{{f}_{PLL}}{{f}_{LCM}} ,$$

which has units of phase in the PLL's clock domain. If f_{LCM} has units of hertz, the final timing uncertainty is f_{LCM}⁻¹ seconds. In some embodiments, the frequencies of f_{osc} and f_{PLL} are chosen such that the least common multiple of their frequencies is large so as to make the final timing uncertainty small. For example, if f_{osc} and f_{PLL} are chosen to be 7 MHz and 4 MHz, respectively, f_{LCM} is 28 MHz, and the final timing uncertainty is approximately 3.5714×10⁻⁸ seconds. In contrast, if f_{osc} and f_{PLL} are chosen to be 7000 kHz and 4001 kHz, the final timing uncertainty is 3.5705×10⁻¹¹ seconds. Thus, f_{PLL} may be chosen such that the phase offset can be estimated with improved accuracy.

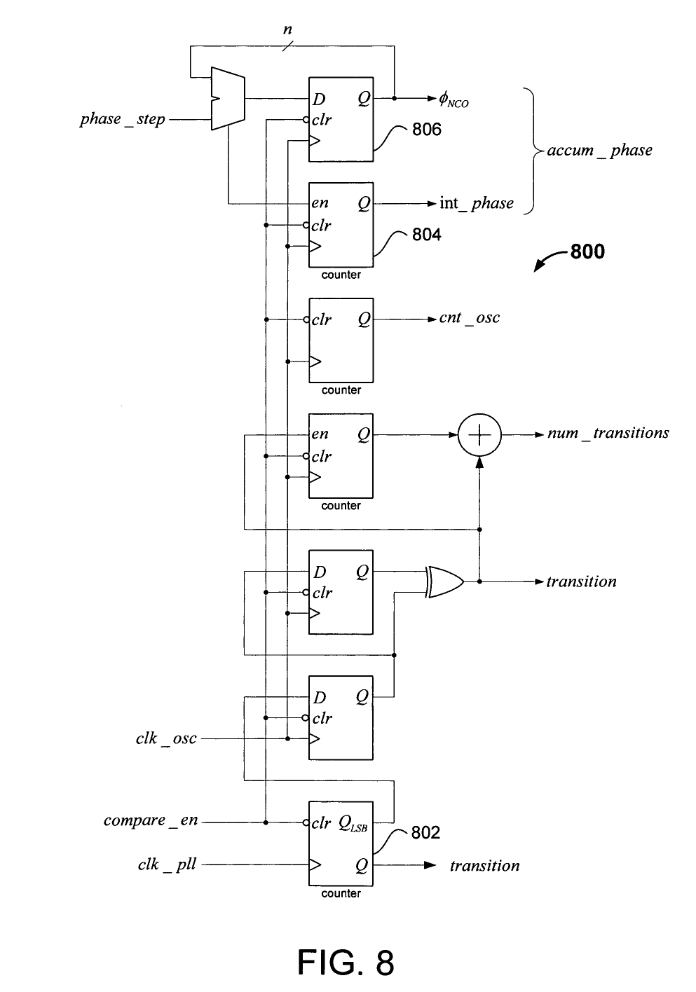

FIG. 8 is a block diagram illustrating an embodiment of a timing module. In this example, timing module 800 includes a plurality of flip-flops/counters. Aside from counter 802, which is clocked by clk_PLL, all other flip-flops and counters are driven by clk_osc. The flip-flops are configured to start running when compare_en is asserted. The signal num_transitions is determined by a counter. The signal accum_phase comprises an integer portion, int_phase, which is tracked by counter 804, and a fractional portion, φ_{NCO}. The fractional phase φ_{NCO}, which corresponds to the output of register 806, is the phase of a numerically controlled oscillator (NCO) which implements equation [2]. The number of bits used in this NCO, denoted as n in FIG. 8, may be approximately 20. An increased number of bits can potentially improve the accuracy of the phase determination at the expense of increased power consumption and area.

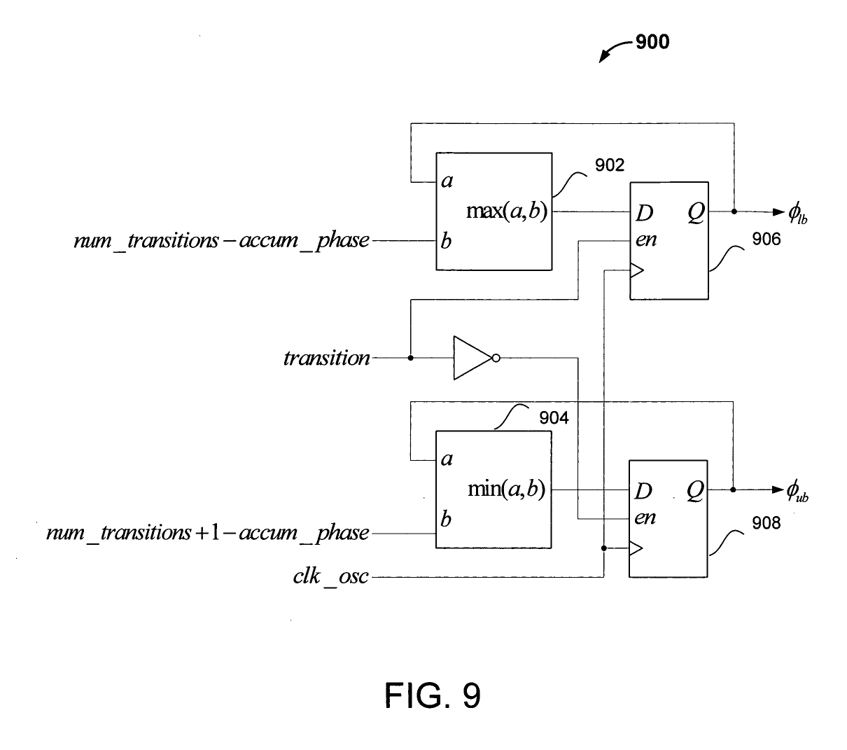

FIG. 9 is a block diagram illustrating an embodiment of a bounds estimator module. In this example, bounds estimator 900 is driven by clk_osc. The outputs from a timing module are modified to obtain num_transitions−accum_phase and num_transitions+1−accum_phase which are sent to maximum detection block 902 and minimum detection block 904, respectively. The transition signal from the timing module indicates whether there was a transition in the cnt_PLL signal in the cycle immediately before, and selectively enables registers either 906, to update φ_{lb} according to [3], or 908, to update φ_{ub} according to [5].

Once the final bounds on the initial phase offset, φ_{lb} and φ_{ub}, are determined, the estimated phase offset \hat{φ}₀ is calculated. In some embodiments, \hat{φ}₀ is the average of the lower and upper bounds. Compensation is performed by incorporating the phase offset into the general GPS computation equations.

A plurality of GPS satellites are in orbit around the earth. Each satellite continuously transmits L-band signals. One of these signals, denoted the L1 signal, has a nominal center frequency of 1575.42 MHz. One of the signals modulated onto this L1 carrier is a length 1023 pseudorandom code denoted the Coarse/Acquisition (C/A). The C/A code has a chipping rate of 1.023 MHz; the code has a period of 1 millisecond. The C/A code is different for each satellite. Each L1 C/A signal is further modulated by a navigation data message. The navigation data message contains information about the satellite orbit, the satellite clock and clock correction terms, and satellite health data. The GPS epoch is defined to be the beginning of the C/A code sequence.

The GPS signal may be tracked by aligning locally generated replicas of the code and carrier signals to the components contained in the received GPS signal corresponding to the desired satellite. This alignment may correspond to maximizing the correlation between the incoming signal and the locally generated replicas. The time of arrival of a satellite may be estimated by observing the epoch of the locally generated C/A sequence corresponding to said satellite. A detailed description of GPS positioning is found in GPS, Theory and Practice, (third, revised edition), B. Hoffman-Wellenhoff, H. Lichtenegger, and J. Collins, Springer Verlag, Wien New York, 1994, ISBN 3-211-82591-6, which is incorporated herein by reference for all purposes.

For the purposes of explaining the present invention, we consider the simplified relationship between the time of arrival measurements and position which ignores satellite clock errors, adjustments for the rotation of the earth, ionospheric delay, and other error sources. In this simplified model, let rᵢ(t) denote the pseudorange, measured by the receiver, of the ith satellite at time t. We denote the pseudorange as the difference in delay between the time of arrival of the epoch and the locally generated clock, i.e.:

rᵢ(t)=ρᵢ(x,y,z,t)−cbᵢ(t)+vᵢ(t), [6]

where bᵢ(t) denotes the receiver clock bias term at time t, c is the speed of light (≈3×10⁸ ms⁻¹), and vᵢ(t) is the measurement error in ith pseudorange. Pseudorange is measured in distance, i.e., time multiplied by the speed of light. The quantity ρᵢ(x,y,z,t) corresponds to the Euclidian distance between the position of the ith satellite and the receiver's antenna at time t. More specifically,

$${ρ}_{i} ( x , y , z , t ) = \sqrt{{( x ( t ) - {x}_{i} ( t ) )}^{2} + {( y ( t ) - {y}_{i} ( t ) )}^{2} + {( z ( t ) - {z}_{i} ( t ) )}^{2}} , \qquad [ 7 ]$$

where x(t), y(t), and z(t) are the spatial coordinates of the antenna, and xᵢ(t), yᵢ(t), zᵢ(t) are those of the ith satellite, all at time t.

Prior to switching to a power saving mode, the relative phase of clk_PLL is measured with respect to clk_osc. Let t_{compare} (1) denote the time at which the phases of clk_PLL and clk_osc are compared and Q_{osc}(1), the state of a free-running counter, responsive to clk_osc, at t_{compare} (1). The resulting phase difference measurement, denoted \hat{φ}₀(1) establishes the relationship between the ADC sampling clock and clk_osc at t_{compare} (1). After switching from a low power mode to a non-low power mode, the phase of clk_PLL is again compared to clk_osc at time t_{compare} (2) when said free-running counter has a state Q_{osc}(2). This yields a phase difference estimate \hat{φ}₀(2). Time t_{compare} (2) obeys the relationship:

$${t}_{compare} ( 2 ) = {t}_{compare} ( 1 ) + \frac{{Q}_{osc} ( 2 ) - {Q}_{osc} ( 1 )}{{f}_{osc}} . \qquad [ 8 ]$$

An estimate of the receiver clock bias at time t_{compare} (2) is given by

$$\hat{b} ( {t}_{compare} ( 2 ) ) = \frac{{\hat{φ}}_{0} ( 2 ) - {\hat{φ}}_{0} ( 1 )}{{f}_{PLL}} + \hat{b} ( {t}_{compare} ( 1 ) ) + \frac{{Q}_{osc} ( 2 ) - {Q}_{osc} ( 1 )}{{f}_{osc}} , \qquad [ 9 ]$$

The term

$$\frac{{\hat{φ}}_{0} ( 2 ) - {\hat{φ}}_{0} ( 1 )}{{f}_{PLL}}$$

in [9] corresponds to shift in the ADC sampling clock due to the random initial phase of the fractional-N synthesizer. The term

$$\hat{b} ( {t}_{compare} ( 1 ) ) + \frac{{Q}_{osc} ( 2 ) - {Q}_{osc} ( 1 )}{{f}_{osc}}$$

in [9] corresponds to the time during which the receiver switched to a power saving mode and back to a non-power saving mode. During this time, the change in receiver clock bias is propagated by considering the frequency of f_{osc} and the number of cycles of this clock that have elapsed.

Alternately, the offset \hat{φ}₀ may be used to adjust pseudorange measurements instead of the clock bias estimate. In this case, the pseudorange measurements may be compensated according to:

$${\hat{ρ}}_{i} = {ρ}_{i} - \frac{( 1 - {\hat{φ}}_{o} )}{{f}_{PLL}} c , \qquad [ 10 ]$$

where c denotes the speed of light.

When the receiver is able to receive signals from 4 or more satellites, the GPS solution, i.e., the position (x, y, z) and the receiver clock bias b using standard GPS positioning techniques.

In some embodiments, to further improve the estimate of the receiver's position and time, a plurality of measurements are taken over time and filtered to produce a result that is based on a current set of measurements, and at least one set of measurements that were taken previously. If the receiver switched from non-power saving mode to power saving mode, then back to non-power saving mode between the current and the previous measurements, the new phase relationship between the ADC sampling clock and reference clock is determined. The position and clock bias estimates can be determined based in part on the current set of GPS measurements and in part on the estimate of position and clock bias at said previous measurement, wherein the clock bias of the previous measurement has been compensated according [9]. In other implementations, the pseudorange measurements may be compensated according to [10] and the clock bias updated based upon the frequency and number of elapsed cycles of clk_osc.

A typical, high quality crystal oscillator may have a time uncertainty after one second of approximately 1×10⁻¹⁰ seconds. This is typically two orders of magnitude smaller than the uncertainty in the clock bias estimate from a single GPS position solution. Hence, propagating the estimate of the clock from prior measurements and incorporating this propagated estimate of the clock in the GPS position computation strengthen the position computation as information beyond that available in the GPS pseudorange measurements is introduced.

The random offset in the ADC sampling clock, associated with returning from the low power mode may substantially weaken the GPS position solution, as it is potentially large compared to the uncertainty in the propagated clock estimate. For example, if the ADC sampling clock frequency (f_{PLL}) is 16 MHz, the standard deviation of the timing offset may be approximately 17.6×10⁻⁹ second. If uncompensated, this timing offset limits the extent to which we can exploit previous knowledge of the GPS receiver's clock bias term. By estimating and compensating for said random offset, the previous clock estimate may be propagated without a substantial increase in error. Moreover, the propagated clock bias estimate may used in solving for the users position without having to discount the reliability of this propagated clock estimate due to an uncompensated random offset.

Let xₖ denote a vector variable comprising the user position state (x, y, z) the user velocity (\dot{x}, \dot{y}, ż), the clock bias b, and the time rate of change of the clock bias, \dot{b}, all at time t=kT, i.e.

xₖ=[x(kT)y(kT)z(kT)\dot{x}(kT)\dot{y}(kT)\dot{z}(kT)b(kT)\dot{b}(kT)]^{T} [11]

Assume that the random components of \hat{x}ₖ are well modeled as evolving according to the stochastic state-space equation

xₖ₊₁=Fxₖ+Guₖ, [12]

where uₖ is the process noise, Euₖuₖ^{T}=Qₖ, E denotes the expectation operator, and (•)^{T} denotes transpose. We see that the next state of x is the superposition of two terms, the current state of x projected ahead in time according to the state transition matrix F and a random input uₖ operated on by a matrix G. The matrices F and G may evolve over time. The measurements of user's position may be related to the relevant states of x according to

yₖ=Hxₖ+vₖ. [13]

Here, H is a matrix relating the states to the measurements in the forward model [13], vₖ is the measurement error, and Evₖvₖ^{T}=Rₖ. In this case, the position of the user may be estimated by incorporating a plurality of measurements taken over time using, for example, Kalman filtering techniques.

Methods of incorporating measurements of disparate uncertainties are described in Optimal Filtering, B. D. O. Anderson and J. Moore, Prentice Hall, Englewood Cliffs, N.J., 1979, ISBN 0-13-638122-7, and Linear Estimation, T. Kailath, A. H. Sayed, and B. Hassibi, Prentice Hall, Englewood Cliffs, N.J., 2000, ISBN 0-13-022464-2, which are incorporated herein by reference for all purposes. The propagated clock estimate may be combined with GPS pseudorange measurements using a Kalman filter. Kalman filtering, as applied to GPS positioning is described in Introduction to Random Signals and Applied Kalman Filtering (second edition), R. G. Brown and P. Y. C. Hwang, John Wiley, New York, 1982, ISBN 0-47152-573-1, which is incorporated herein by reference for all purposes. For the purposes of example, a simplified Kalman smoothing filter example in which the states evolve according to a stochastic model defined by [12] and [13] is discussed below.

The Kalman smoother, which provides a causal estimate after the measurement update, comprises two steps: a propagation step and measurement update step. The propagation step comprises projecting the estimated state and covariance ahead according to:

\hat{x}_{k+1|k}=F\hat{x}ₖ [14]

and

P_{k+1|k}=FPF^{T}+GQₖG^{T}. [15]

Here, \hat{x}_{k+1|k} denotes the estimate of the state for time instant k+1 given the measurements up to time instant k. The term P_{k+1|k} denotes the covariance of the estimate \hat{x}_{k+1|k}.

The measurement update comprises computing the covariance of estimated state for time instance k+1, given the measurements up to and including time instance k+1, and using this updated covariance in the computation of the estimated state. The covariance is updated according to:

P_{k+1|k+1}=(P_{k+1|k+1}⁻¹+HR⁻¹H^{T})⁻¹. [16]

The updated state estimate is formed according to:

\hat{x}_{k+1|k+1}=\hat{x}_{k+1|k}+P_{k+1|k+1}⁻¹H^{T}R⁻¹(y−H×\hat{x}_{k═k+1}) [17]

The Kalman smoothing filter is seen to have time varying gains for the measurements; in particular, the weight given to the new measurement is in proportion to the prior uncertainty in the estimated quantity and in inverse proportion to the uncertainty in the measurement. The timing offset estimation may be used to improve the propagated clock estimate using the Kalman filter. A process noise model for Qₖ is determined wherein the entries associated with the clock bias uncertainty may be chosen to reflect whether or not the GPS receiver transitioned to, and subsequently from, a low power mode since the last measurement update. If said transitions did not occur, the entries of Qₖ are chosen to reflect only the uncertainty in the timebase since the last measurement update. If said transitions did occur, the elements of Qₖ are chosen to reflect the uncertainty in the timebase and the residual uncertainty in the phase offset estimation, which is a function of the difference between the upper and lower bounds on the phase offset, φᵤ and φₗ, respectively. The lack of phase offset estimation is seen as a limiting case in which the upper and lower bounds on the phase are 1 and 0 respectively, and which causes the propagated clock bias estimate to be substantially discounted.

Although the foregoing embodiments have been described in some detail for purposes of clarity of understanding, the invention is not limited to the details provided. There are many alternative ways of implementing the invention. The disclosed embodiments are illustrative and not restrictive.

What is claimed is:

1. A Global Positioning System (GPS) receiver configurable to switch between a power saving mode and a non-power saving mode, comprising:
a reference oscillator configured to provide a reference clock;
a frequency synthesizer coupled to the reference oscillator, configured to provide a sampling clock to an analog to digital converter; and
a compensation module configured to compensate for a change in phase relationship between the sampling clock and the reference clock, the change resulting from the GPS receiver switching between the power saving mode and the non-power saving mode.

2. The GPS receiver of claim 1, wherein the frequency synthesizer is a fractional-N synthesizer.

3. The GPS receiver of claim 1, wherein compensating for the change in phase relationship includes estimating the phase relationship between the sampling clock and the reference clock.

4. The GPS receiver of claim 1, wherein compensating for the change includes determining an upper bound and a lower bound of the phase relationship.

5. The GPS receiver of claim 4, wherein the upper bound and the lower bound are determined based at least in part on a determination of whether a phase transition in the sampling clock occurred in a previous cycle of the reference clock.

6. The GPS receiver of claim 4, wherein the upper bound and the lower bound are determined iteratively.

7. The GPS receiver of claim 4, wherein the upper bound and the lower bound are determined iteratively, and the estimation terminates when the difference between the upper bound and the lower bound meets a predetermined threshold.

8. The GPS receiver of claim 4, wherein the upper bound and the lower bound are determined iteratively, and the estimation terminates after a predetermined number of iterations.

9. The GPS receiver of claim 4, wherein the upper bound and the lower bound are determined based at least in part on a determination of whether a phase transition in the reference clock occurred in a previous cycle of the sampling clock.

10. The GPS receiver of claim 1, wherein compensating for the change in phase relationship includes estimating the phase relationship based at least in part on one or more transitions in a signal corresponding to the reference clock, one or more transitions in a signal corresponding to the sampling clock, and a frequency ratio between the reference clock and the sampling clock.

11. The GPS receiver of claim 3, wherein the estimated phase relationship is used in GPS position calculation.

12. The GPS receiver of claim 3, wherein the estimated phase relationship is used to compensate a GPS measurement.

13. The GPS receiver of claim 12, wherein the GPS measurement includes a pseudorange.

14. The GPS receiver of claim 3, wherein the estimated phase relationship is used to determine a receiver clock bias.

15. The GPS receiver of claim 1, wherein compensating for the change in phase relationship includes making a first estimate of the phase relationship between the reference clock and the sampling clock, and making a second estimate of the phase relationship between the reference clock and the sampling clock.

16. The GPS receiver of claim 15, wherein the first estimate is made during the non-power saving mode, and there are a first transition to the power saving mode and a second transition to the non-power saving mode before the second estimate is made.

17. The GPS receiver of claim 16, wherein an estimate of a receiver clock bias is made based at least in part on the receiver clock bias estimate prior to entering the power saving mode, and the second estimate of the phase relationship.

18. The GPS receiver of claim 1, wherein compensating for the change in phase relationship includes estimating a receiver clock bias using a filter with a time varying gain.

19. The GPS receiver of claim 1, wherein the filter is, a Kalman filter.

20. A method for processing a global positioning system (GPS) signal, comprising:
switching a GPS receiver configuration between a non-power saving mode and a power saving mode, the GPS receiver comprising a reference oscillator configured to provide a reference clock, and a frequency synthesizer coupled to the reference oscillator, configured to provide a sampling clock to an analog to digital converter; and
compensating for a change in phase relationship between the sampling clock and the reference clock, the change resulting from the GPS receiver switching between the power saving mode and the non-power saving mode.

21. The method of 20, wherein compensating for the change in phase relationship includes estimating the phase relationship between the sampling clock and the reference clock.

22. The method of 21, wherein compensating for the change in phase relationship includes determining an upper bound and a lower bound of the phase relationship.

23. A computer program product processing a global positioning system (GPS) signal, the computer program product being embodied in a computer readable storage medium and comprising computer instructions for:
switching a GPS receiver configuration between a non-power saving mode and a power saving mode, the GPS receiver comprising a reference oscillator configured to provide a reference clock, and a frequency synthesizer coupled to the reference oscillator, configured to provide a sampling clock to an analog to digital converter; and
compensating for a change in phase relationship between the sampling clock and the reference clock, the change resulting from the GPS receiver switching between the power saving mode and the non-power saving mode.

24. The computer program product of 23, wherein compensating for the change in phase relationship includes estimating the phase relationship between the sampling clock and the reference clock.

25. The computer program product of 24, wherein compensating for the change in phase relationship includes determining an upper bound and a lower bound of the phase relationship.
